(19) United States
(12) Patent Application Publication
(10) Pub. No.: US 2025/0369604 A1
(43) Pub. Date: Dec. 4, 2025

(54) Track Lighting System With Integrated DMX Control Signal Splitter, Isolator And/Or Booster

(71) Applicant: Lighting Services, Inc, Stony Point, NY (US)

(72) Inventors: Brian Joseph Leonardo, Verona, NJ (US); Nicholas Matthew Downham, Stony Point, NY (US); Michael Fevola, Stony Point, NY (US)

(21) Appl. No.: 19/226,068

(22) Filed: Jun. 2, 2025

Related U.S. Application Data
(60) Provisional application No. 63/654,471, filed on May 31, 2024.

(51) Int. Cl. F21V 21/35

(52) U.S. Cl. CPC F21V 21/35

(57) ABSTRACT

A track lighting system with integrated control signal isolator, splitter, and/or repeater is adapted to receive controllable lighting fixtures and other output devices and includes at least one rigid track section having internal power conductors and internal data conductors provided within the track section. The power and data conductors are separated and electrically isolated from each other. The track section has one or more of an optical isolator, an optical splitter, and an optical repeater, provided within the at least one track section. The optical components are in electrical continuity with the data conductors and electrically isolate a section of the data conductors of the track section and transmit control signals carried on the electrically isolated data conductors to an adjacent section of the data conductors.

### FIELD OF THE INVENTION

The present invention relates to a field of lighting technology, and in particular to track lighting systems in which track elements contain both power supply and a control data conductors to deliver power and control data to lighting units and other output units mounted to the track lighting system.

### BACKGROUND OF THE INVENTION

Several control protocols are known and have been in use in controlling lighting systems. These include the 0-10V protocol, the Digital Serial Interface (DSI) protocol, the Digital Addressable Lighting Interface (DALI) protocol (IEC 62386), and the DMX512 protocols.

The DMX512 (Digital Multiplex with 512 pieces of information) digital communication standard is used to control theatrical lighting and effects, as well as other lighting applications. The current DMX specification is DMX512-A (ANSI E1.11-2008, USITT DMX512-A), and as used herein, DMX512 encompasses all version of DMX512. DMX512 uses a unidirectional EIA-485 (RS-485) voltage level signaling at its physical layer, in conjunction with a packet-based communication protocol. The unidirectional signal travels in one direction, from a controller or first light, to a terminator. A terminator is a stand-alone male connector with an integral 120Ω resistor connected across the primary control signal pair. The terminator resistor which is typically installed at the end of a DMX line of devices reduces the possibility of signal reflection which can create errors in the DMX signal.

A DMX512 network employs a multi-drop topology with nodes strung together in a daisy chain. A network consists of a single DMX512 controller (e.g. a lighting console) and a plurality of controlled devices (e.g. lighting fixtures). DMX512 allows for 32 unit loads (individual devices connected) to be placed on a single cable. If more than 32 unit loads need to communicate, the network can be expanded across parallel cables using DMX splitters.

In hardware terms, DMX512 protocol information is transferred between devices via cables containing metal wires using the RS-485 hardware protocol and connected with 5 pin DMX connectors. Each channel has a pair of wires, one of which is a data+ wire, one of which is a data− wire. A low voltage signal can be transmitted, for example, to transmit a logical one, the data+ wire set to positive five volts, and the data− wire is set to zero volts. To transmit a logical zero, the data+ wire is set to zero volts, and the data− wire is set to positive five volts. The 5 pin DMX connectors provide connections for the signal common, data 1+, data 1−, data 2+, and data 2− wires.

The data layer of a DMX512 controller consists of data packets that each consist of 512 channels of data, with each channel having a value of between 0 and 255. All 512 channels are transmitted in one block, sequentially. Generally, a block is transmitted 30-40 times per second. The DMX receiver is assigned a DMX address which is one of the channels between 1 and 512. A DMX address, also known as a start address, indicates from which channel in a block the data is used by a fixture. If a controlled device such as a lighting fixture is an RGBW fixture with a start address of 10, it will retrieve the value of red from channel 10, green from channel 11, blue from 12, and white from 13. Each controlled light unit will typically use between 1-4 channels, for example, using one channel each for control of Red, Blue and Green, or in more complex control schemes, using one channel each for to control multiple colors, rotation, and strobe. In a typical application, each DMX data byte transmitted has one start bit, which is used to warn the receiver that the next character is starting, eight data bits (this conveys up to two hundred fifty six different levels) and two stop bits, which are used to tell the receiver that this is the end of the character. In this way, the DMX512 control signal instructs a receiving device, such as a light to illuminate a certain color, or a dimmer to dim the light to a specified level.

Wireless DMX512 has become available through the use of wireless DMX512 adapters. These adapters include a wireless transmitter at the DMX controller which receives DMX512 control signals, converts them to a wireless signal and transmits the wireless signal to a wireless receiver near the controlled devices. The wireless receiver converts the wireless signal back to conventional DMX512 wired network signals and transmits them to the controlled devices.

Track systems are a support track (sometimes called a rail) on which individual light fixtures are mounted. The track system provides power to the fixture through power conductors located within the support track. There are many different track cross sectional layouts. The most common in North America are the H type, J type, and L type, developed respectively by the Halo, Juno, and Lightolier companies. Generally, the track is an extruded aluminum track section which is hollow and which contains an electrically insulating insert that runs the length of the track section (usually along the inside side walls of the track section). Exposed power conductors run the length of the track section along the inside side walls of the electrically insulating insert. The track has an open slot running the length of the track section on its lower face. Lighting fixtures (sometimes called track heads) can be mounted to the track by inserting a fixture end into the slot and rotating the fixture end until it is locked in place with contacts placed against and receiving power from the power conductors.

A track system is typically assembled from a components which are typically primary track sections, joiner track sections, and track end sections. The track lighting system is assembled from these components to fit the particular space in which the track lighting system is installed.

Track systems may be adapted for three-phase 230V power (used for commercial and industrial systems), 120V power (residential or commercial use), or low voltage power (12V or 24V) (residential or commercial use).

Some embodiments of track systems provided both power conductors and data conductors within the support track rail. The track sections have a plurality of longitudinal guide ways containing insulating insert(s) containing exposed power conductors and data conductors. The power and data conductors are electrically isolated from each other by the insulating insert(s). In these embodiments, controllable lighting fixtures and other controllable output devices are mounted to the track sections and have connectors to contact and receive power and data from the power conductors and data conductors. The lighting fixtures typically are LED luminaires containing a number of LEDs, often in groups of specific colors. The lighting fixtures typically include a control unit to receive data from the data conductor and to selectively energize LEDs using power from the power conductor to illuminate the lighting fixture according to instructions received via the data conductor.

Prior art FIG. 1 shows cross sectional details of a primary track section 20 forming part of a track lighting system. Track section 20 is adapted for surface mounting on the lower surface of a ceiling or other planar surface. Track section 20 an aluminum extrusion and has vertical side walls 21, 22 and an open bottom 23. Electrical insulators 24, 25, typically of plastic material, are secured to the interior of the track section 20 on the respective side walls 21, 22. Insulator 24 is provided with a pair of channels open to the central part of the track section 20. The upper channel contains a power conductor 26 which is a neutral busbar suitable for carrying electrical current at 120-277 V. The lower channel contains a power conductor 27 which is a line busbar suitable for carrying electrical current at 120-277 V. The insulator 25 is provided with three channels which are also open to the central part of the track section 20. The three channels each contain a data busbar, specifically data busbar 1 at 30, data busbar 2 at 29, and data busbar 3 at 28.

A plurality of track sections 20 can be assembled in various configurations, with the power 26, 27 and data 30, 29, 28 conductors in the different track sections 20 connected together by electrical connectors provide continuity of power and data throughout the entire track system.

Prior art FIG. 2 shows cross sectional details of another type of track section 31. Track section 31 is adapted for recessed mounting in a channel or rectangular aperture in a ceiling or other planar surface. Otherwise track section 31 is essentially similar to the surface-mounted track section 20 of FIG. 1. The functional elements of track section 31 that correspond to the elements of the track section 20 have the same reference numerals. In particular, track section 31 is an aluminum extrusion containing insulators 24, 25. Insulator 24 contains power conductors 26 and 27, and insulator 25 contains three data busbars 30, 29, and 28.

Prior art FIGS. 3 and 4 illustrate how controlled devices, typically but not necessarily lighting fixtures, are operatively mounted to a track 20 or track 31 of a track system as described above. A light fixture 45 with a controlled light emitter is mounted on a vertical stem 46 provided at its upper end with a rotary mounting head 47. The mounting head 47 is provided on opposite sides with mounting wings 48 which fit between opposed support flanges 49 at the bottom of the track section, when the mounting head is rotated to an install/remove position and which overlie and are supported by the flanges 49 when the mounting head is rotated to a lock position, shown in FIGS. 3 and 4. The rotary mounting head 47 also mounts rotary contact arms 50, 51 (power) and 52-54 (data), which project from opposite sides of the mounting head 47 and are aligned with the power 26-27 and data 28-30 conductors when the fixture is mounted in a track section 20 or 31. Like the mounting wings 48, the contact arms 50-54 fit between the support flanges 49 when the mounting head 47 is rotated to an install/remove position. After insertion, the mounting head is rotated to bring the mounting wings into positions overlying and supported by the flanges 49, and simultaneously to bring the contact arms 50-54 into tight electrical contact with the respective power and data conductors.

It is possible to implement the DMX512 protocol in a track lighting system by providing data conductors which correspond to the data conductors of the DMX512 protocol. In FIG. 1, data busbars 1 at 30, 2 at 29, and 3 at 28 are DMX512 compatible and are used for transmission of DMX signals received from a DMX controller to a controlled device such as a lighting fixture. In such case, the light fixture 45 seen in FIGS. 3 and 4 has a DMX512 control unit that is controlled from a DMX console (such as a laptop).

An issue that can arise in DMX512 controlled track lighting systems is loss of control signal integrity due to voltage fluctuations in the data conductor. DMX512 does not include automatic error checking and correction and there is the potential for false triggering of a lighting fixture due to control signal errors in the data conductor caused by electromagnetic interference, static electricity discharges, improper track termination, excessively long tracks, poor quality data conductors in the track, or current leakage from the power conductors. Hazardous voltages may occur and travel on the data conductor due to dimmer failures, electrical storms, and cross wiring non-DMX equipment (foggers, intercoms, arc welders) into the data conductor.

It would be desirable for a DMX512 controlled track lighting system to be provided with improvements which minimize or prevent loss of control signal integrity.

### SUMMARY OF THE INVENTION

A track system for individually controllable output devices such as light fixtures with an integrated control signal optical isolator, optical splitter, and/or optical repeater is adapted to receive controllable lighting fixtures and includes at least one rigid track section having internal power conductors and internal data conductors provided within the track section. The power and data conductors are separated and electrically isolated from each other. The track section has one or more of an optical isolator, an optical splitter, and an optical repeater, provided within the at least one track section. The optical components are in electrical continuity with the data conductors and electrically isolate a section of the data conductors of the track section and transmit control signals carried on the electrically isolated data conductors to an adjacent section of the data conductors. The one or more of an optical isolator, an optical splitter, and an optical repeater are powered by a power supply or power supplied by the power conductors. In a preferred embodiment, the control signals are DMX512 signals.

The at least one rigid track section is a primary track section, a joiner track section, or a track end section. A joiner track section may take the form of a straight joiner track section for connecting 2 primary track sections, or the joiner track section may be configured in the form of an “L”, or a “T”, or an “X” for connecting 2, 3, or 4 primary track sections.

In some embodiments, one or more individually controllable output devices such as lighting fixtures are mounted on the track system, and have first contact elements connected to the power conductors and second contact elements connected to the data conductors.

### BRIEF DESCRIPTION OF THE DRAWINGS

FIG. 1 is an end cross sectional view of a prior art track section adapted for surface mounting on a ceiling or other surface.

FIG. 2 is an end cross sectional view of a prior art track section adapted for recessed mounting on a ceiling or other surface

FIG. 3 is an end cross sectional view of a prior art track section showing a controllable output device such as a lighting fixture mounted on the track section.

FIG. 4 is an enlarged view of FIG. 3 illustrating details of the mounting and electrical connection of the controllable output device such as a light fixture to the track section.

FIG. 5 is a bottom orthographic view of a straight joiner track section for surface mount having one or more of an optical isolator, optical splitter, and optical repeater.

FIG. 6 is a bottom orthographic view of a “L” shaped joiner track section for surface mount having one or more of an optical isolator, optical splitter, and optical repeater.

FIG. 7 is a bottom orthographic view of a “T” shaped joiner track section for surface mount having one or more of an optical isolator, optical splitter, and optical repeater.

FIG. 8 is a bottom orthographic view of a “X” shaped joiner track section for surface mount having one or more of an optical isolator, optical splitter, and optical repeater.

FIG. 9 is a bottom orthographic view of a track end section for recessed mount having one or more of an optical isolator, optical splitter, and optical repeater.

FIG. 10 is a bottom orthographic view of the track end section for recessed mount of FIG. 9 with an associated recessed mount primary track section.

FIG. 11 is an exploded bottom perspective view of a track end section for flush mount, attached to a primary track section for flush mount, having one or more of an optical isolator, optical splitter, and optical repeater with an associated flush mount track segment.

FIG. 12 is an assembled bottom perspective view of the flush mount track end section and primary track section of FIG. 11.

FIG. 13 is a bottom plan view of the flush mount track end section and primary track section of FIG. 12.

FIG. 14 is a schematic illustration of the components of an DMX512 optical isolator.

### DETAILED DESCRIPTION OF THE INVENTION

Applicant incorporates by reference the disclosure of U.S. Patent Publication No. US 2024 0085009 A1.

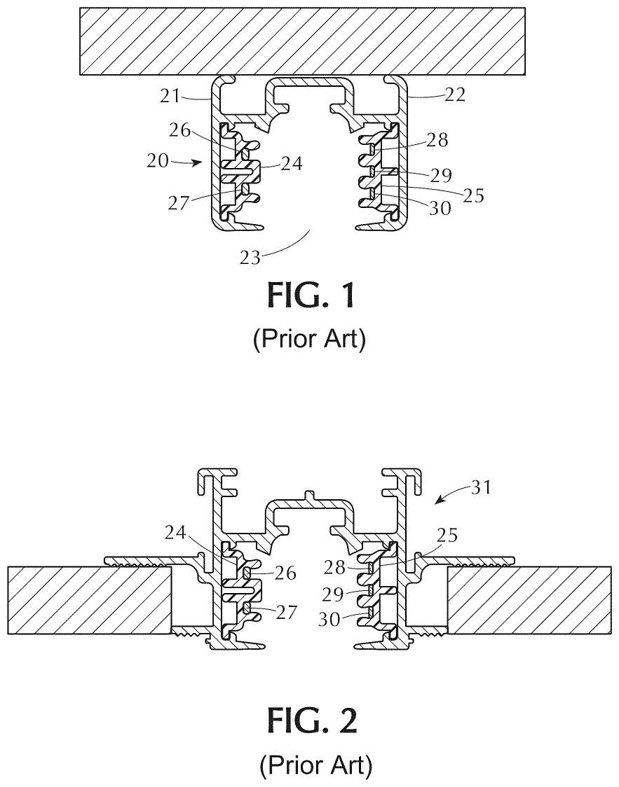

As previously described, FIG. 1 shows cross sectional details of a primary track section 20 forming part of a track lighting system. Track section 20 is adapted for surface mounting on the lower surface of a ceiling or other planar surface. Track section 20 an aluminum extrusion and has vertical side walls 21, 22 and an open bottom 23. Electrical insulators 24, 25, typically of plastic material, are secured to the interior of the track section 20 on the respective side walls 21, 22. Insulator 24 is provided with a pair of channels open to the central part of the track section 20. The upper channel contains a power conductor 26 which is a neutral busbar suitable for carrying electrical current at 120-277 V. The lower channel contains a power conductor 27 which is a line busbar suitable for carrying electrical current at 120-277 V. The insulator 25 is provided with three channels which are also open to the central part of the track section 20. The three channels each contain a data busbar, specifically data busbar 1 at 30, data busbar 2 at 29, and data busbar 3 at 28. Data busbars 1, 2, and 3 are DMX512 compatible and are used for transmission of DMX signals received from a DMX controller to a controlled device such as a lighting fixture. A plurality of track sections 20 can be assembled in various configurations, with the power 26, 27 and data 30, 29, 28 conductors in the different track sections 20 connected together by electrical connectors provide continuity of power and data throughout the entire track system.

FIG. 2 shows cross sectional details of a track section 31 adapted for recessed mounting in a channel or rectangular aperture in a ceiling or other planar surface. Track section 31 is an aluminum extrusion containing insulators 24, 25. Insulator 24 contains power conductors 26 and 27, and insulator 25 contains three data busbars 30, 29, and 28.

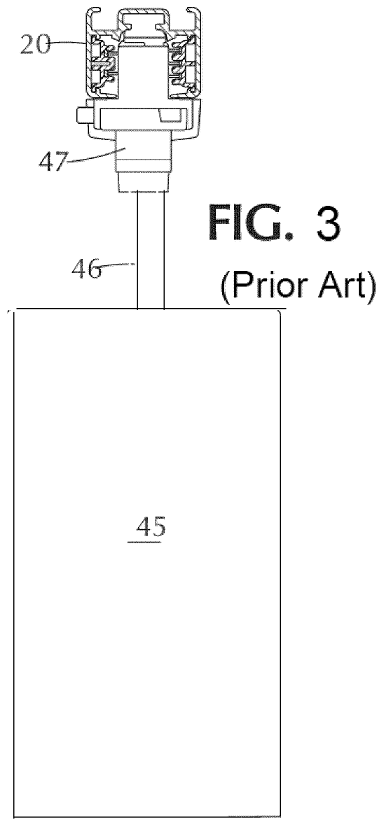

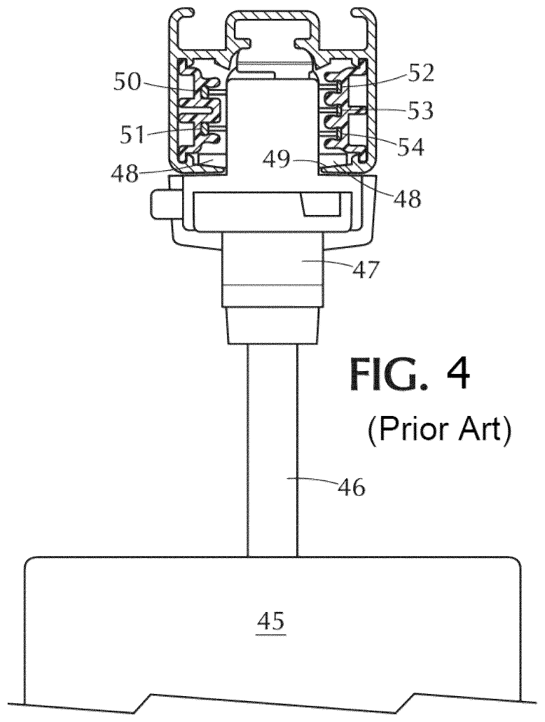

FIGS. 3 and 4 illustrate how controlled devices, typically but not necessarily lighting fixtures, are operatively mounted to a track 20 or track 31 of a track system as described above. A light fixture 45 with a DMX controlled light emitter is mounted on a vertical stem 46 provided at its upper end with a rotary mounting head 47. The mounting head 47 is provided on opposite sides with mounting wings 48 which fit between opposed support flanges 49 at the bottom of the track section, when the mounting head is rotated to an install/remove position and which overlie and are supported by the flanges 49 when the mounting head is rotated to a lock position. The rotary mounting head 47 also mounts rotary contact arms 50, 51 (power) and 52-54 (data), which project from opposite sides of the mounting head 47 and are aligned with the power 26-27 and data 28-30 conductors when the fixture is mounted in a track section 20 or 31. Like the mounting wings 48, the contact arms 50-54 fit between the support flanges 49 when the mounting head 47 is rotated to an install/remove position. After insertion, the mounting head is rotated to bring the mounting wings into positions overlying and supported by the flanges 49, and simultaneously to bring the contact arms 50-54 into tight electrical contact with the respective power and data conductors.

As previously stated, there is an issue with potential loss of control signal integrity due to voltage fluctuations in the data conductor, which has the potential for false triggering of a lighting fixture due to control signal errors in the data conductor. An optical isolator or opto-isolator is an electronic component that separates two parts of an electrical system from each other so that they are electrically isolated from each other while at the same time an electrical signal on the first part of the system is transmitted to the second part of the system where it is acted on by components in the second part of the system. The optical isolator accomplishes this by receiving the electrical signal on the first part of the system, converting it to an optical signal, then transmitting the optical signal to a photosensor, which converts the optical signal back to an electrical signal which is then transmitted to the second part of the system. FIG. 16 illustrates a schematic of the components of an optical isolator 1000. Isolator 1000 has a power supply which will typically be a +5V DC power supply. In many typical embodiments, an optical isolator contains an emitter which is a near infrared light-emitting diode (LED), that converts electrical input signal into light, a closed optical channel, and a photosensor which is photoresistor, a photodiode, a phototransistor, a silicon-controlled rectifier or a triac, which detects incoming light and either generates an electrical signal directly or modulates a current to create the electrical signal. A common type of opto-isolator consists of an LED and a phototransistor in the same opaque package. The optical isolator 1000 in FIG. 16 includes a DMX input 1010 that send signal to an optical driver 1012. Optical driver 1012 sends an optical signal to the optical isolator 1014. The received optical signal is converted to a DMX signal via the data driver 1016. The DMX signal is output via DMX Output 1018. U.S. Pat. No. 4,262,220, which is incorporated by reference, provides additional background on the construction of optical isolators. Use of an optical isolator in a DMX control system improves the quality of the system accuracy and control.

Another optical component which is useful in a DMX control system is an optical splitter with an optical isolator, which allows splitting of a signal into different paths and also acts to prevent signal error propagation along the different paths. U.S. Pat. No. 5,680,246, which is incorporated by reference, provides additional background on the construction of optical splitters.

An optical repeater (also called an opto-repeater, amplifier, or booster) is useful to enhance the strength of the signal transmitted on the paths, particularly if there is a long run to a controlled device. Multiple lines of DMX data can be distributed through an opto-repeater. U.S. Pat. Nos. 5,680,246 and 6,657,778, which are incorporated by reference, provide additional background on the construction of optical repeaters and amplifiers.

In practice, an opto-isolator, an opto-repeater, and an optical splitter are all similar devices which provide an electrical isolation between two parts of a system, while allowing signal propagation through the device by transforming the electrical signal into an optical signal which spans a gap, then transforming the optical signal back to an electrical signal. The input electrical signal is recreated at the output at full strength and can be output along multiple data conductors.

In the present systems, any of the many commercially available DMX Optical Isolators can be used, however, due to their smaller form factor, inline optical isolators such as the ELM Video Technology, Inc. Product Code DXI-PCB DMX In Line Optical Isolator PCB, or the Product Code DBOP DMX Full Optical Isolated PCB with Power Supplies will be desirable. However, nearly any commercially available opto-isolator, opto-repeater, and optical splitter can be used, and of course custom designed and manufactured packages can be used.

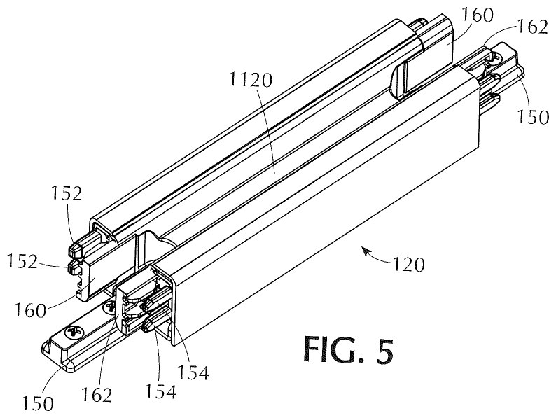

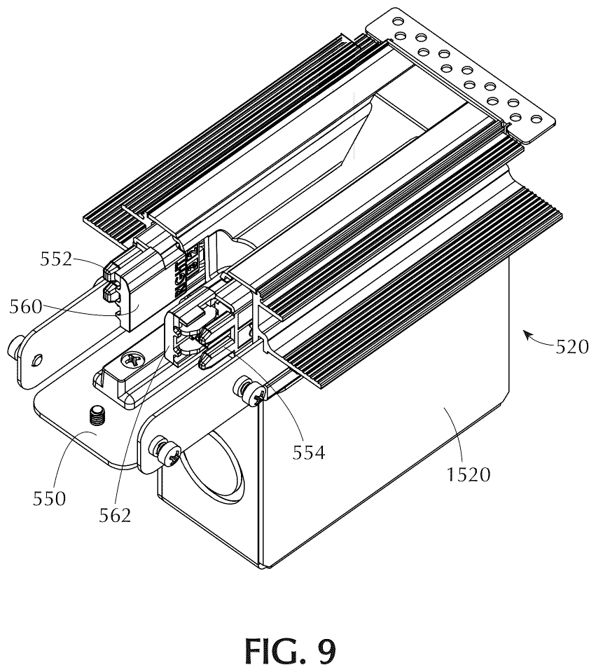

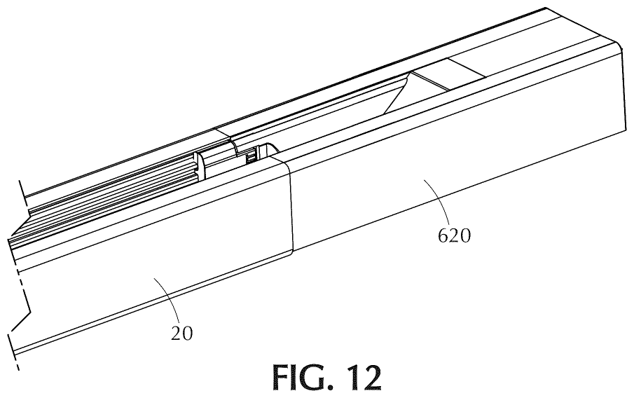

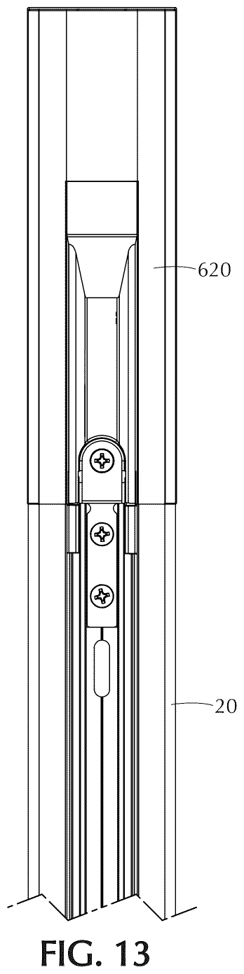

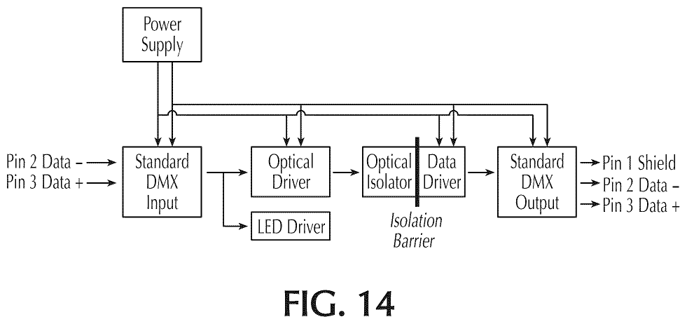

The present invention provides a track system for the mounting of a plurality of controllable lighting fixtures and other controllable output devices comprising a track section having an integrated control signal splitter, isolator and/or booster. In the typical application, the track system comprises a plurality of track sections 20 and one or more connector sections 120, 220, 320, or 420 (FIGS. 5-8) for joining adjacent track sections, and an end section 520, 620 (FIGS. 9-13), the track sections 20 and connector sections 120, 220, 320, or 420 and end section 520, 620 (FIGS. 9-13) being provided internally with power conductors 26, 27 and data conductors 28, 29, 30, the track sections being formed with a longitudinally extending opening 23 along an exposed wall thereof adapted for the reception and mounting of one or more output devices 45, where the output devices have first electrical contacts 50, 51 engageable with the power conductors 26, 27 and second electrical contacts 52, 53, 54 engageable with the data conductors 28, 29, 30, one or more track sections and/or connector sections and/or a track end section having included therein one or more of an optical isolator 1000, optical splitter, and optical repeater, and having electrical contacts engageable with the data conductors 28, 29, 30, whereby the one or more of an optical isolator 1000, optical splitter, and optical repeater acts on control signals carried on the data conductors 28, 29, 30. Preferably, the optical isolator 1000, optical splitter, and optical repeater are directly connected to the data conductors 28, 29, 30 and are integrated into a track section 20 or a connector section 120, 220, 320, or 420 or an end section 520, 620.

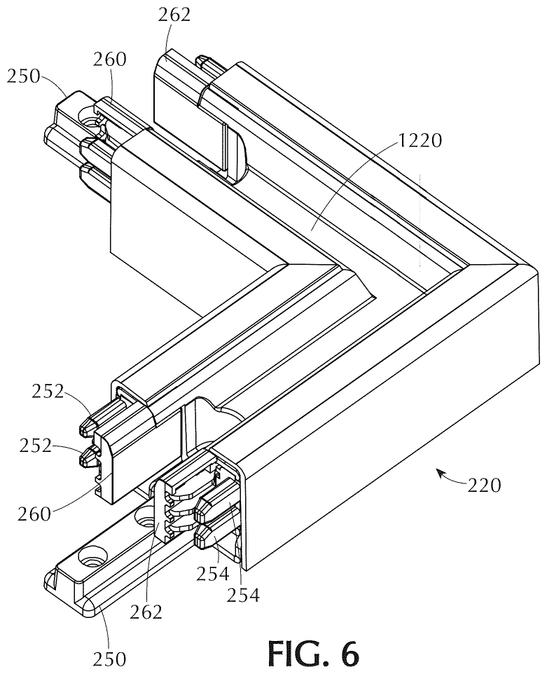

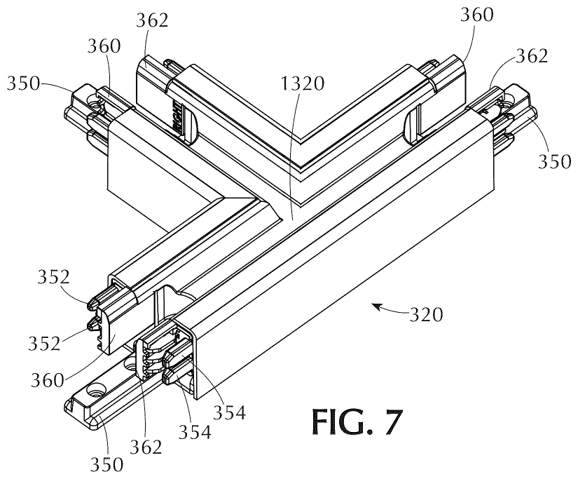

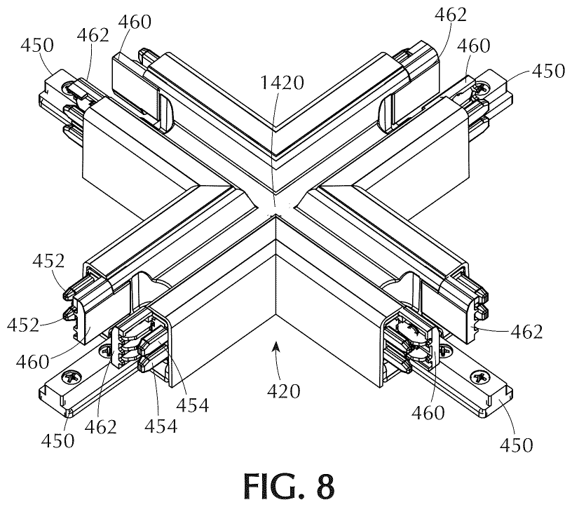

In some embodiments, the one or more of an optical isolator, optical splitter, and optical repeater are located in a connector section, also referred to herein as a joiner track section, which may be a straight joiner track section as seen in FIG. 5, or a joiner track section is configured in the form of an “L” (as seen in FIG. 6), or a “T” (as seen in FIG. 7), or an “X” (as seen in FIG. 8) for connecting 2, 3, or 4 track sections.

The joiner track sections each include an aluminum track body containing electrically insulated power conductors and electrically insulated data buses for transmission of DMX512 signals. One or more of an optical isolator, optical splitter, and optical repeater are provided in the track in electrical communication with the data buses. The one or more of an optical isolator, optical splitter, and optical repeater are powered by power supplied by the power conductors. The joiner track sections have extending tongues that slot into corresponding channels in the track sections joined together by the joiner track sections.

In other embodiments, the one or more of an optical isolator, optical splitter, and optical repeater is connected to a track end section (as seen in FIGS. 9-12). The track end section includes a DMX terminator having a 120 (resistor connected across a control signal pair.

In other embodiments, the one or more of an optical isolator, optical splitter, and optical repeater are indirectly connected to the data conductors by being connected to the track system using an adapter.

In some embodiments, the one or more of an optical isolator, optical splitter, and optical repeater are powered by power supplied by the power conductors.

In some embodiments, the one or more of an optical isolator, optical splitter, and optical repeater are powered by power supplied by a power line which is separate from the power conductors.

Referring now to FIG. 5, connector section is a straight joiner track section 120 which has extending tongues 150 that slot into corresponding channels in the track sections joined together by the straight joiner track section 120. Pins 152 and 154 align and connect the joiner track section 120 with adjacent track sections. Electrical connector 160 connects to the power conductors 26 and 27 of the adjacent track section. Electrical connector 160 is provided with internal power conductors extending the length of joiner track section 120 to a second electrical connector 160. Data connector 162 connects to the data conductors 28, 29, and 30 of the adjacent track section. Data connector 162 is provided with internal data conductors extending to one or more of an optical isolator, optical splitter, and optical repeater 1120 provided in the body of the straight joiner track section 120. Further data conductors extend from the optical isolator, optical splitter, or optical repeater 1120 to a second data connector 162 at the other end of the straight joiner track section 120. The optical isolator, optical splitter, and optical repeater 1120 are powered from the internal power conductors.

Referring now to FIG. 6, connector section is an L-shaped joiner track section 220 which has extending tongues 250 that slot into corresponding channels in the track sections joined together by the L-shaped joiner track section 220. Pins 252 and 254 align and connect the joiner track section 220 with adjacent track sections. Electrical connector 260 connects to the power conductors 26 and 27 of the adjacent track section. Electrical connector 260 is provided with internal power conductors extending through joiner track section 220 to a second electrical connector 260. Data connector 262 connects to the data conductors 28, 29, and 30 of the adjacent track section. Data connector 262 is provided with internal data conductors extending to one or more of an optical isolator, optical splitter, and optical repeater 1220 provided in the body of the joiner track section 220. Further data conductors extend from the optical isolator, optical splitter, or optical repeater 1220 to a second data connector 262 at the other end of the L-shaped joiner track section 220. The optical isolator, optical splitter, and optical repeater 1220 are powered from the internal power conductors.

Referring now to FIG. 7, connector section is an T-shaped joiner track section 320 which has extending tongues 350 that slot into corresponding channels in the track sections joined together by the T-shaped joiner track section 320. Pins 352 and 354 align and connect the joiner track section 320 with adjacent track sections. Electrical connector 360 connects to the power conductors 26 and 27 of the adjacent track section. Electrical connector 360 is provided with internal power conductors extending through joiner track section 320 to second electrical connectors 360. Data connector 362 connects to the data conductors 28, 29, and 30 of the adjacent track section. Data connector 362 is provided with internal data conductors extending to one or more of an optical isolator, optical splitter, and optical repeater 1320 provided in the body of the joiner track section 320. Further data conductors extend from the optical isolator, optical splitter, or optical repeater 1320 to second data connectors 362 at the other end of the T-shaped joiner track section 320. The optical isolator, optical splitter, and optical repeater 1320 are powered from the internal power conductors.

Referring now to FIG. 8, connector section is an X-shaped joiner track section 420 which has extending tongues 450 that slot into corresponding channels in the track sections joined together by the X-shaped joiner track section 420. Pins 452 and 454 align and connect the joiner track section 420 with adjacent track sections. Electrical connector 460 connects to the power conductors 26 and 27 of the adjacent track section. Electrical connector 460 is provided with internal power conductors extending through joiner track section 420 to second electrical connectors 460. Data connector 462 connects to the data conductors 28, 29, and 30 of the adjacent track section. Data connector 462 is provided with internal data conductors extending to one or more of an optical isolator, optical splitter, and optical repeater 1420 provided in the body of the joiner track section 420. Further data conductors extend from the optical isolator, optical splitter, or optical repeater 1420 to second data connectors 462 at the other end of the T-shaped joiner track section 420. The optical isolator, optical splitter, and optical repeater 1420 are powered from the internal power conductors.

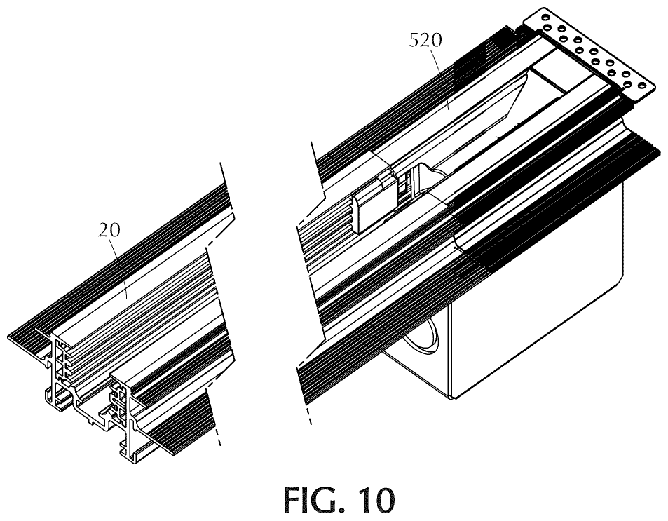

Referring now to FIGS. 9 and 10, an end track end section 520 for recessed mounting in a ceiling surface has an extending tongue 550 that slots into a corresponding channel in the track section before the end section 520. Pins 552 and 554 align and connect the end track section 520 with the adjacent track section. Electrical connector 560 connects to the power conductors 26 and 27 of the adjacent track section. Electrical connector 560 is provided with internal power conductors extending through the end section 520. Data connector 562 connects to the data conductors 28, 29, and 30 of the adjacent track section. Data connector 562 is provided with internal data conductors extending to one or more of an optical isolator, optical splitter, and optical repeater 1520 provided in the body of the end section 520. The optical isolator, optical splitter, and optical repeater 1520 are powered from the internal power conductors or a power line provided in association with the end section. 520.

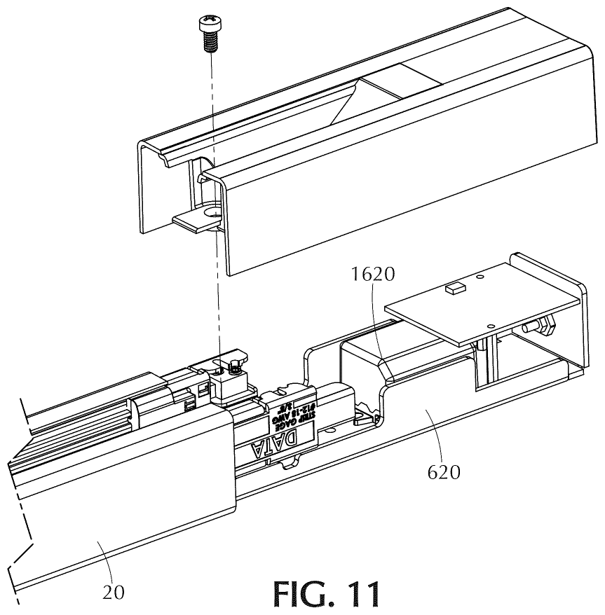

Referring now to FIGS. 11-13, an end track end section 620 for flush mounting in a ceiling has one or more of an optical isolator, optical splitter, and optical repeater 1620 provided in the body of the end section 620. Track end section 620 connects to an adjacent track section 20 as described in the previous embodiments.

A track system constructed with a primary track section, joiner track section, or end section and described above will have a plurality of individually controllable output fixtures mounted onto the track system. The individually controllable output fixtures have first contact elements to connect to the power conductors and second contact elements to connect to the data conductors. A control member transmits output device-controlling signals via the data conductors to one or more selected output devices mounted on the track system for independently addressable control of a plurality of output devices on the track system.

Accordingly, the present invention provides a track lighting system that separates different sections of the track lighting system to prevent the propagation of voltage fluctuations that can impact or alter the control signals

It should be understood that the specific embodiments of the invention herein illustrated and described are intended as representative only and do not define the limits of the invention. Reference should therefore be made to the following appended claims in determining the full scope of the invention.

1. A track system for receiving controllable output devices, comprising:
at least one rigid track section;
the at least one track section having at least one internal power conductor and at least one internal data conductor provided within the at least one track section, the internal power conductor and internal data conductor being separated and electrically isolated from each other;
the at least track section having one or more of an optical isolator, an optical splitter, and an optical repeater, provided within the at least one track section in electrical continuity with the data conductor, whereby the one or more of an optical isolator, optical splitter, and optical repeater electrically isolate a section of the data conductor of the at least one track section and transmit control signals carried on the data conductor from the electrically isolated section of the data conductor to an adjacent section of the data conductor.

2. The track system of claim 1, wherein the at least one track section is a primary track section, a joiner track section, or a track end section.

3. The track system of claim 2, wherein the at least one track section is a joiner track section configured in the form of an “L”, or a “T”, or an “X” for connecting 2, 3, or 4 primary track sections.

4. The track system of claim 2, wherein the at least one track section is a joiner track section which is a straight joiner track section for connecting 2 primary track sections.

5. The track system of claim 2, wherein the at least one track section is a track end section.

6. The track system of claim 2, wherein the at least one track section is primary track section.

7. The track system of claim 1, wherein the one or more of an optical isolator, an optical splitter, and an optical repeater are electrically connected to and powered by the power conductor.

8. The track system of claim 1, further comprising one or more individually controllable output lighting fixtures mounted on the track system and having a first contact element connected to the power conductor and a second contact element connected to the data conductor.

9. The track system of claim 1, further comprising one or more individually controllable output devices mounted on the track system and having a first contact element connected to the power conductor and a second contact element connected to the data conductor.

10. The track system of claim 1, wherein the control signals are DMX512 signals.

11. A connector section for joining adjacent track sections in a track system, the connector section including a track containing an electrically insulated power conductor and an electrically insulated data conductor for transmission of DMX512 signals, the connector section having one or more of an optical isolator, an optical splitter, and an optical repeater, provided within the connector section in electrical continuity with the data conductor, whereby the one or more of an optical isolator, optical splitter, and optical repeater electrically isolate a section of the data conductors of the at least one track section and transmit control signals carried on the data conductor from the electrically isolated section of the data conductor to an adjacent section of the data conductor.

12. The connector section of claim 11, wherein the connector track section is a straight joiner track section for connecting 2 primary track sections.

13. The connector section of claim 11, wherein the connector track section is configured in the form of an “L”, or a “T”, or an “X” for connecting 2, 3, or 4 primary track sections.

14. The connector section of claim 11, wherein the one or more of an optical isolator, an optical splitter, and an optical repeater are powered by power supplied by the power conductor.

15. A track end section for terminating a primary track section in a track system, the track end section including a track containing an electrically insulated power conductor and an electrically insulated data conductor for transmission of DMX512 signals, the track end section having one or more of an optical isolator, an optical splitter, and an optical repeater, provided within the connector section in electrical continuity with the data conductor, whereby the one or more of an optical isolator, optical splitter, and optical repeater electrically isolate a section of the data conductor of the at least one track section and transmit control signals carried on the data conductor from the electrically isolated section of the data conductor to an adjacent section of the data conductor.

16. The track end section of claim 15, wherein the one or more of an optical isolator, an optical splitter, and an optical repeater are powered by power supplied by the power conductor.

17. The track end section of claim 15, wherein there are at least two data conductors and further comprising a resistor connected across the at least two data conductors.
